(19) United States
(12) Patent Application Publication
(10) Pub. No.: US 2018/0296930 A1
(43) Pub. Date: Oct. 18, 2018

(54) DEVICE, METHOD, AND COMPUTER PROGRAM FOR PROVIDING GAME SERVICE

(71) Applicant: VISUALSHOWER CORP., Gangnam-gu, Seoul (KR)

(72) Inventor: Hong Kwan PARK, Mapo-gu (KR)

(21) Appl. No.: 15/579,874

(22) PCT Filed: Jun. 7, 2016
(86) PCT No.: PCT/KR2016/005973

§ 371 Date: Dec. 5, 2017

(30) Foreign Application Priority Data
Jun. 5, 2015 (KR) 10-2015-0080035

(51) Int. Cl. A63F 13/95; A63F 13/79; A63F 13/73; A63F 13/69

(52) U.S. Cl. CPC A63F 13/95; A63F 13/69; A63F 13/73; A63F 13/79

(57) ABSTRACT

A device, a method, and a computer program for providing a game service. The game service providing device for changing a level of a target card by using a source card that includes a communicator configured to receive target card readout information of the target card and source card readout information of the source card, an account manager configured to change the level of the target card based on the target card readout information and the source card readout information, and a database configured to store information about the target card.

### CROSS REFERENCE TO RELATED APPLICATIONS

This application is the National Stage of International Application No. PCT/KR2016/005973, having an International Filing Date of 7 Jun. 2016, which designated the United States of America, and which International Application was published under PCT Article 21 (2) as WO Publication No. 2016/195446 A1, and which claims priority from and the benefit of Korean Application No. 10-2015-0080035, filed on 5 Jun. 2015, the disclosures of which are incorporated herein by reference in their entirety.

### BACKGROUND

### 1. Field

Aspects of the presently disclosed embodiment relate to a device, a method, and a computer program for providing a game service.

### 2. Brief Description of Related Developments

Online game items are tools that exist on games in various ways so as to add pleasure to users enjoying games through the Internet by wire or by wireless.

Such items are traded online and are traded offline in the form of cards, toys, and the like. Various methods of acquiring items traded in the form of cards, toys, and the like on online games are being developed.

### SUMMARY

Aspects of the presently disclosed embodiment provide a device, a method, and a computer program for providing a game service.

According to an aspect of the presently disclosed embodiment, a game service providing device for changing a level of a target card by using a source card includes a communicator configured to receive target card readout information of the target card and source card readout information of the source card, an account manager configured to change the level of the target card based on the target card readout information and the source card readout information, and a database configured to store information about the target card.

According to aspects of the presently disclosed embodiment, it is possible to provide a device, a method, and a computer program for providing a game service.

### BRIEF DESCRIPTION OF THE DRAWINGS

FIG. 1 is a block diagram schematically illustrating a game service providing device according to an aspect of the presently disclosed embodiment.

FIG. 2 is a diagram illustrating the relationship between a card, a payment code reader, and a game service providing device according to an aspect of the presently disclosed embodiment.

FIG. 3 is a diagram schematically illustrating a structure of a card according to an aspect of the presently disclosed embodiment.

FIG. 4 is a flow diagram schematically illustrating a card activating method for providing a game service according to an aspect of the presently disclosed embodiment.

FIG. 5 is a diagram illustrating a card account generated by a game service providing device according to an aspect of the presently disclosed embodiment.

FIGS. 6A and 6B are diagrams illustrating a target card account and a source card account generated by a game service providing device according to an aspect of the presently disclosed embodiment.

FIG. 7 is a diagram illustrating the relationship between a card, a card reader, a terminal, and a game service providing device according to an aspect of the presently disclosed embodiment.

FIG. 8 is a block diagram schematically illustrating a terminal according to an aspect of the presently disclosed embodiment.

FIG. 9 is a flow diagram schematically illustrating a game service providing method according to an aspect of the presently disclosed embodiment.

FIGS. 10A and 10B are diagrams illustrating card accounts updated by a game service providing device according to an aspect of the presently disclosed embodiment.

### DETAILED DESCRIPTION

The advantages and features of the presently disclosed embodiment and methods for achieving the same will become apparent from the following aspects that are described in detail in conjunction with the accompanying drawings. However, it should be understood that these aspects are not construed as limited to the illustrated forms and include all changes, equivalents, or alternatives within the idea and the technical scope of the presently disclosed embodiment. The following aspects are provided so that this disclosure will be thorough and complete, and will fully convey the scope of the disclosed embodiment to those skilled in the art. In the following descriptions, descriptions of well-known functions and constructions will be omitted if they are considered to unnecessarily obscure the gist of the presently disclosed embodiment.

The terminology used herein is for the purpose of describing particular aspects only and is not intended to limit the scope of the presently disclosed embodiment. As used herein, the singular forms “a”, “an”, and “the” are intended to include the plural forms as well, unless the context clearly indicates otherwise. It will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof. It will be understood that although the terms “first”, “second”, etc. may be used herein to describe various components, these components should not be limited by these terms. These components are only used to distinguish one component from another.

The terms “communication”, “communication network”, “Internet network”, and “network” used herein may be used as the same meaning. The above terms mean a wired or wireless local and wide area data transmission and reception network that enables files to be transmitted and received between a user terminal, terminals of other users, and a download server.

In the present specification, when one component “transmits” data to another component, it means that the component may transmit the data directly to the other component, or may transmit the data to the other component through at least one other component.

In contrast, when one component “directly transmits” data to another component, it means that the data is transmitted to the other component without passing through another component.

The terms “unit” and “module” used herein may mean a functional and structural combination of hardware for performing the technical spirit of the presently disclosed embodiment and software for driving the hardware. For example, the term “module” may mean a logical unit of predetermined codes and hardware resources for performing the predetermined codes, and it will be apparent to those skilled in the art that the module is not limited to physically connected codes or one type of hardware.

Hereinafter, aspects of the presently disclosed embodiment will be described in detail with reference to the accompanying drawings, and in the drawings, like reference numerals denote like elements, and a redundant explanation thereof will not be provided herein.

FIG. 1 is a block diagram schematically illustrating a game service providing device according to an aspect of the presently disclosed embodiment.

Referring to FIG. 1, a game service providing device 10 according to an aspect of the presently disclosed embodiment may include a communicator 11, an account manager 12, and a database 13.

The communicator 11 may receive payment code readout information of a card.

The payment code readout information may include transaction information such as transaction identification information, store code, product information, and transaction amount.

The transaction identification information may be a unique transaction number generated when an approval request is made to a financial server for a transaction, may be used for transaction inquiry or error tracking, and may be necessary to cancel a transaction.

The store code maybe a combination of alphanumeric and/or numeric codes assigned to a store, and may be used to identify a store at the time of transaction processing.

The product information may be a code for identifying a product, and the payment code readout information may include product information about a card or product information about a card bundle. The product information about a card bundle may include a plurality of product information corresponding respectively to a plurality of cards included in a card bundle, but is not limited thereto.

The communicator 11 may receive card readout information of a card.

The card readout information may include card information and/or item information.

The card information may include card identification information for identifying a card, and the item information may include item identification information for identifying an item included in a card.

The communicator 11 may transmit at least one of a card account generation notification and card level change display information. The card account may refer to a job region including one or more fields for storing card-related information. The card level may refer to the card itself or the level of an item included in the card. For example, the card level maybe automatically changed when the experience value according to the use history of an item included in the card is accumulated and becomes a predetermined value. Hereinafter, a case where the card level is changed by card reading according to aspects of the presently disclosed embodiment will be described in more detail.

For example, the communicator 11 may transmit a card account generation notification corresponding to the payment code readout information to a payment code reader that has generated and transmitted the payment code readout information.

As another example, the communicator 11 may transmit the card level change display information corresponding to the card readout information to the terminal that has generated and transmitted the card readout information, but is not limited thereto.

The account manager 12 may generate a card account corresponding to the card based on the payment code readout information received through the communicator 11. For example, the account manager 12 may generate a card account corresponding to a card based on the payment code readout information including the product information about a card. As another example, the account manager 12 may generate a plurality of card accounts corresponding respectively to a plurality of cards included in a card bundle, based on the payment code readout information including the product information about the card bundle.

The account manager 12 may generate a card account by generating a field for storing information about the card account in the database 13, which will be described later. The field may refer to a predetermined data storage designation region in a storage region of the database 13.

The information about the card account may include at least one of card identification information for identifying the card, card classification information indicating whether the card is a level change target card or a level change source card, card level information indicating the current level of the card, and item identification information for identifying an item included in the card.

According to an aspect, the account manager 12 may generate at least one of a card identification information field, a card classification information field, a card level information field, and an item identification information field in the database 13.

For example, when receiving first payment code readout information including target card identification information from the communicator 11, the account manager 12 may generate a target card account corresponding to a target card based on the first payment code readout information, and store the target card identification information in the card identification information field or store target card classification information indicating that the target card is a level change target card in the card classification information field or store first target card level information, for example, default information in the card level information field or store item identification in format ion in the item identification information field.

As another example, when receiving second payment code readout information including source card identification information from the communicator 11, the account manager 12 may generate a source card account corresponding to a source card based on the second payment code readout information, and store the source card identification information in the card identification information field or store source card classification information indicating that the source card is a level change source card in the card classification information field or store first source card level information indicating the source card has a value as the target card level change source in the card level information field or store information indicating no item in the item identification information field.

The account manager 12 may change the level of the target card based on the card readout information. The card readout-information may be target card readout information and source card readout information. The target card readout information may include at least one of target card identification information, target card classification information, target card level information, and item identification information, and the source card readout information may include at least one of source card identification information, source card classification information, and source card level information.

The account manager 12 may change the level of the target card by storing the newly changed target card level information in the card level information field based on the card readout information.

According to an aspect, the account manager 12 may generate new target card level information of the target card based on the target card readout information of the target card and the source card readout information of the source card, The account manager 12 may specify the target card whose level is to be changed based on the target card readout information and may determine the current card level of the specified target card. The account manager 12 may determine the current card level of the target card from the target card readout information or may determine the current card level of the target card from the information stored in the card level information field of the target card account of the specified target card, but is not limited thereto. The account manager 12 may acquire a level change source based on the source card readout information and apply the level change source to the current card level of the specified target card to generate the newly changed target card level information. The account manager 12 may store the newly changed target card level information in the card level information field of the target card account.

For example, based on the target card readout information including the first target card level information, the account manager 12 may determine that the target card whose level is to be changed is a first card and the current card level of the first card is a default level. The account manager 12 may acquire a level 1 change source based on the source card readout information and apply the level 1 change source to the default level of the first card to generate second target card level information indicating the level 1. The account manager 12 may store the second target card level information in the card level information field of the first card account.

According to another aspect, the account manager 12 may generate new source card level information of the source card based on the target card readout information of the target card and the source card readout information of the source card, The account manager 12 may specify the source card based on the source card readout information and acquire the level change source from the specified source card. The account manager 12 may determine the current card level of the source card from the source card readout information or may determine the current card level of the source card from the information stored in the card level information field of the source card account of the specified source card, but is not limited thereto. When the result of acquiring the level change source indicates that no more level change source remains in the corresponding source card, the account manager 12 may generate new source card level information indicating that there is no value as a level change source. The account manager 12 may store the new source card level information in the card level information field of the source card account.

For example, the account manager 12 may determine, based on the source card readout information, that the source card is a second card and the second card has a value as a source currently, and may acquire a level 1 change source based on the first source card level information. When the result of acquiring the level 1 change source from the second card indicates that no more level change source remains in the second card, the account manager 12 may generate second source card level information indicating that there is no value as a level change source. When the result of acquiring the level 1 change source from the second card indicates that a level change source remains in the second card, the account manager 12 may generate third source card level information indicating that there is a value as a level change source. The account manager 12 may store the second source card level information or the third source card level information in the card level information field of the second card account.

When the information stored in the card level information field is changed, the account manager 12 may generate the card level change display information.

According to an aspect, when the newly changed target card level information of the target card is stored in the card level information field of the target card account, the account manager 12 may generate new target card level display information. For example, when the second target card level information is stored in the card level information field of the first card account that is the target card, the account manager 12 may generate information indicating that the card level of the first card has been changed to the level 1.

According to another aspect, when the new source card level information of the source card is stored in the card level information field of the source card account, the account manager 12 may generate new source card level display information. For example, when the second source card level information is stored in the card level information field of the second card account that is the source card, the account manager 12 may generate information indicating that the second card may no longer be utilized as the source card, As another example, when the third source card level information is stored in the card level information field of the second card account that is the source card, the account manager 12 may generate information indicating how many times the second card may be utilized as the source card in the future, but is not limited thereto.

The account manager 12 may change the level of the target card by a plurality of levels based on the target card readout information of the target card and a plurality of source card readout information of a plurality of source cards.

The database 13 may store information about, the card account. The database 13 may store information about at least one card account under the control of the account manager 12.

As such, according to the aspects of the presently disclosed embodiment, the utility of a game card may be improved by utilizing the source card, which is a dummy card, to change the card level of the target card.

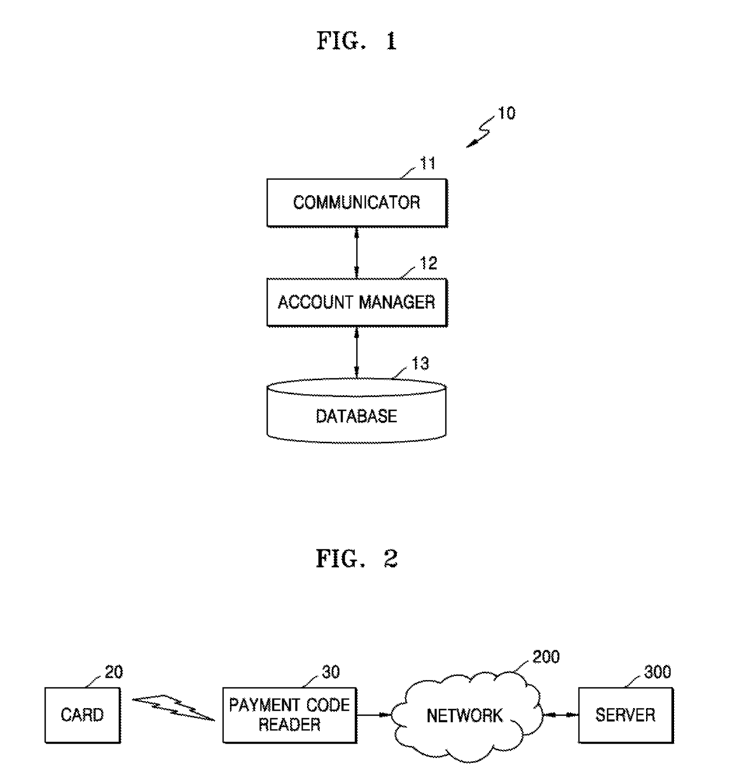

FIG. 2 is a diagram illustrating the relationship between a card, a payment code reader, and a game service providing device according to an aspect of the presently disclosed embodiment.

Referring to FIG. 2, a game service providing device 10 according to an aspect of the presently disclosed embodiment may be implemented in a server 300 and may be connected to a payment code reader 30 through a network 200 including a wired and/or wireless communication network such as the Internet and/or an intranet. That is, the game service providing device 10 may be distinguished from the payment code reader 30 and may be connected to the network 200 while being separated from the payment code reader 30.

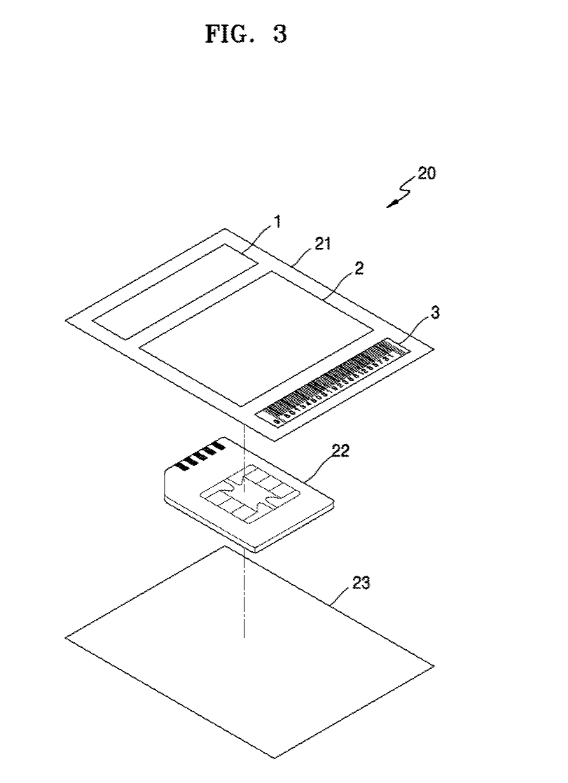

The payment code reader 30 may read the payment code provided in a card 20 and generate payment code readout information including transaction information such as transaction identification information, store code, product information, and transaction amount. Hereinafter, the card 20 read by the payment code reader 30 according to an aspect of the presently disclosed embodiment will be described in more detail with reference to FIG. 3.

FIG. 3 is a diagram schematically illustrating a structure of a card according to an aspect of the presently disclosed embodiment.

Referring to FIG. 3, the card 20 may include at least one radio frequency module 22 between two covers 21 and 23.

The covers 21 and 23 may be paper, plastic, or the like, but are not limited thereto. An item title 1, an item image 2, and/or a payment code 3 may be displayed on the first cover 21. The item title 1 may include, for example, letters, numbers, and/or symbols indicating an item or a game service in which an item is used. The item image 2 may include an image of an item displayed on a game service.

The payment code 3 may be read by the payment code reader 30. The payment code 3 may be a QR code, a two-dimensional code such as a barcode, an IC chip, or the like, but is not limited thereto. The payment code reader 30 may read the payment code 3 displayed on the covers 21 and 23 of the card 20 to generate payment code readout information of the card 20, and may read the payment code displayed on a cover of a card bundle (not illustrated) including the card 20 to generate payment code readout information of the card bundle (not illustrated).

The radio frequency module 22 may be read by a radio frequency reader. The payment code 3 and the radio frequency module 22 may be read by different readers.

The radio frequency module 22 may operate in a predetermined radio frequency band. A plurality of radio frequency modules included each of a plurality of cards may operate in different radio frequency bands, and a radio frequency reader may simultaneously read a plurality of radio frequency modules of each of a plurality of cards constituting a card bundle (not illustrated).

The radio frequency module 22 of the card 20 according to an aspect of the presently disclosed embodiment may include objects, such as characters, items, or cashes, that may be used on the game service providing device 10 according to aspects of the presently disclosed embodiment. The following description of an item card may also be applied to a character card or a cash card as it is.

According to another aspect of the presently disclosed embodiment, the radio frequency module 22 of the card 20, which is classified as the level change target card, may include objects, such as characters, items, or cashes, that may be used on the game service providing device 10 according to aspects of the presently disclosed embodiment, and the radio frequency module 22 of the card 20, which is classified as the level change source card, may not include objects, such as characters, items, or cashes, that may be used on the game service providing device 10 according to aspects of the presently disclosed embodiment.

According to an aspect of the presently disclosed embodiment, the reading of the radio frequency module 22 by the radio frequency reader may only mean in an activation mode of the card 20, in which the payment code 3 is read by the payment code reader 30, the payment code readout information is generated, and the card account corresponding to the card 20 is generated based on the payment code readout information. In a deactivation mode of the card 20, in which the payment code 3 is not read by the payment code reader 30 or the payment code readout information is not generated or the card account corresponding to the card 20 is not generated based on the payment code readout information, even when the radio frequency module 22 is read by the radio frequency reader, an item may not be used on-line on the basis thereof.

That is, the game service providing device 10 according to an aspect of the presently disclosed embodiment may perform control such that an item available on-line may be acquired only for the purchased card 20.

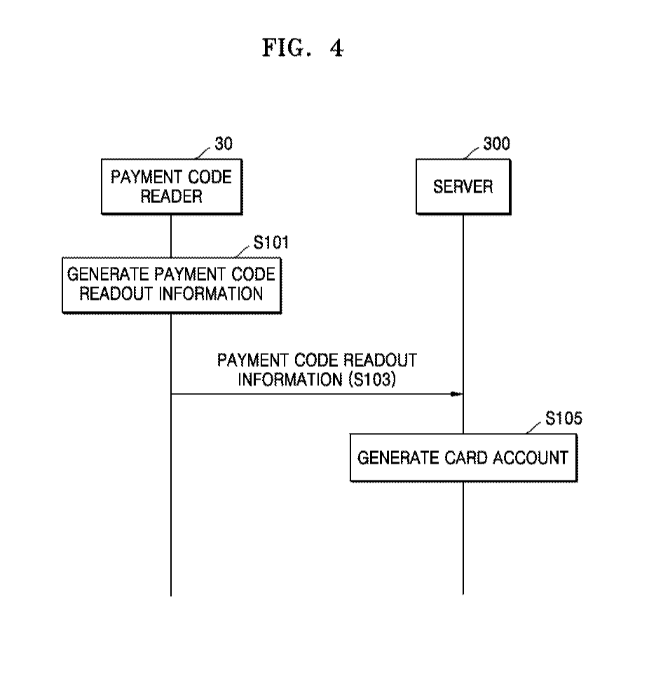

FIG. 4 is a flow diagram schematically illustrating a card activating method for providing a game service according to an aspect of the presently disclosed embodiment.

Referring to FIG. 4, as described above, the payment code reader 30 may read the payment code provided in the card 20 and generate payment code readout information (S101).

When receiving payment code readout information through the network 200 (S103), the server 300 in which the game service providing device 10 according to an aspect of the presently disclosed embodiment is implemented may generate a card account corresponding to the card 20 based on the payment code readout information (S105).

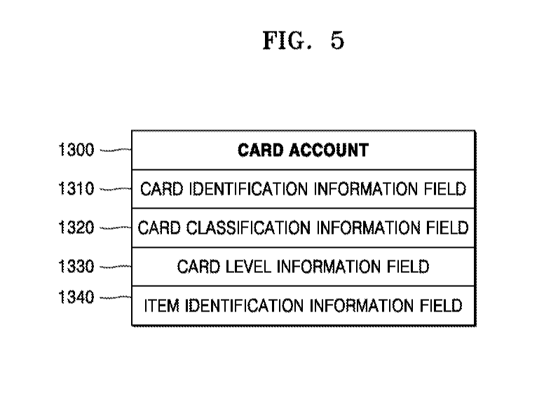

The server 300 may generate a card account corresponding to the card 20 by generating a field for storing information about the card account in the storage region. Hereinafter, a field for storing information about a card account will be described in detail with reference to FIG. 5.

FIG. 5 is a diagram illustrating a card account generated by a game service providing device according to an aspect of the presently disclosed embodiment.

Referring to FIG. 5, when a card account 1300 is generated according to an aspect of the presently disclosed embodiment, at least one of a card identification information field 1310, a card classification information field 1320, a card level information field 1330, and an item identification information field 1340 may be generated of the generated card account 1300 in the storage region of the database 13.

The card identification information field 1310 may store card identification information for identifying the card, the card classification information field 1320 may store card classification information indicating whether the card is a level change target card or a level change source card, the card level information field 1330 may store card level information indicating the current level of the card, and the item identification information field 1340 may store item identification information for identifying the item included in the card or information indicating that the card does not include an item.

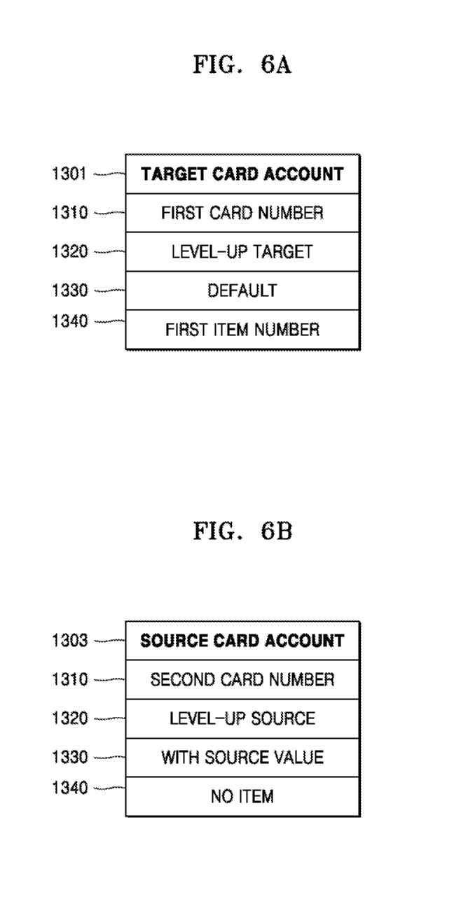

FIGS. 6A and 6B are diagrams illustrating a target card account and a source card account generated by a game service providing device according to an aspect of the presently disclosed embodiment.

Referring to FIG. 6A, when receiving the first payment code readout information including the target card identification information, the server 300 according to an aspect of the presently disclosed embodiment may generate a target card account 1301 corresponding to the first payment code readout information, and store the target card identification information, for example, the first card number in the card identification information field 1310 or store the target card classification information indicating that the card is a level-up target card in the card classification information field 1320 or store the first target card level information, for example, default information indicating that the card is an initial level in the card level information field 1330 or store the first item number in the item identification information field 1340.

Referring to FIG. 6B, when receiving the second payment code readout information including the source card identification information, the server 300 according to an aspect of the presently disclosed embodiment may generate a source card account 1303 corresponding to the second payment code readout information, and store the source card identification information, for example, the second card number in the card identification information field 1310 or store the source card classification information indicating that the card is a level-up source card in the card classification information field 1320 or store the first source card level information indicating that the card has a value as a level change source of the target card in the card level information field 1330 or store information indicating no item in the item identification information field 1340.

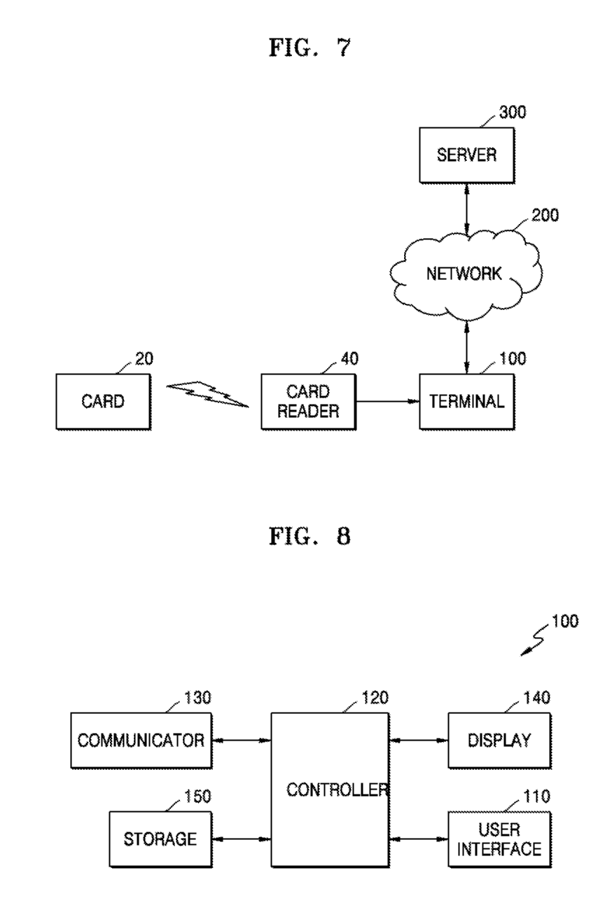

FIG. 7 is a diagram illustrating the relationship between a card, a card reader, a terminal, and a game service providing device according to an aspect of the presently disclosed embodiment.

Referring to FIG. 7, a game service providing device 10 according to an aspect of the presently disclosed embodiment may be implemented in a server 300 and may be connected to a terminal 100 through a network 200 including a wired and/or wireless communication network such as the Internet and/or an intranet. That is, the game service providing device 10 may be distinguished from the terminal 100 and connected to the network 200 while being separated from the terminal 100.

Although not illustrated, a game service providing device 10 according to another aspect of the presently disclosed embodiment may be included in the terminal 100. There may be various methods in which the game service providing device 10 of the present aspect is included in the terminal 100. As an aspect, each of the users may install the game service providing device 10 in the terminal 100 through the network 200, and for example, the game service providing device 10 may be installed in the terminal 100 in the form of one application. As another aspect, the game service providing device 10 may be installed in the terminal 100 through the off-line. However, the inventive concept is not limited thereto, and may include a case where the game service providing device 10 may be installed in various forms in the terminal 100. The terminal 100 may include the game service providing device 10 in a controller 120 illustrated in FIG. 8, which will be described later, or may further include the game service providing device 10 in addition to the controller 120.

Although not illustrated, the game service providing device 10 according to another aspect of the presently disclosed embodiment may not necessarily have to be implemented as any one physical device. That is, the game service providing device 10 may be implemented by organically combining a plurality of physical devices. To this end, some of the configurations included in the game service providing device 10 may be implemented or installed in any one physical device, and some of the configurations may be implemented or installed in any other physical device. In this case, the other physical device may be implemented as a portion of the terminal 100.

According to some examples of implementation, the components (units) included in the game service providing device 10 may be distributed over different physical devices, and the distributed components may be organically combined to perform the functions and/or operations defined herein.

A card reader 40 may read the radio frequency module 22 provided in the card 20 and generate card readout information including card identification information and item identification information.

The card reader 40 may be a radio frequency reader and may simultaneously read a plurality of radio frequency modules provided in a plurality of cards to generate a plurality of card readout information.

The card reader 40 and the terminal 100 may be connected by wire or wireless. For example, the card reader 40 may include a connector connected to an 8-pin port provided in the terminal 100. Although not illustrated, the card reader 40 may be provided in the terminal 100.

The terminal 100 may transmit the information generated by reading the card 20 by the card reader 40 to the server 300 through the network 200, and may receive a game service providing screen, such as a card account generation notification and card level change display information, from the server 300 through the network 200.

The terminal 100 maybe a mobile terminal such as a notebook, a handheld device, a smartphone, a tap, a desktop computer, or any suitable device that uses such device or is directly or indirectly connected thereto. Hereinafter, the terminal 100 according to an aspect of the presently disclosed embodiment will be described in more detail with reference to FIG. 8.

FIG. 8 is a block diagram schematically illustrating a terminal according to an aspect of the presently disclosed embodiment.

Referring to FIG. 8, a terminal 100 may include a user interface 110, a controller 120, a communicator 130, a display 140, and a storage 150.

The user interface 110 may provide an interface with a user for controlling the operation of the terminal 100. The user interface 110 may receive a user's operation signal and transmit the received operation signal to the controller 120. For example, the user interface 110 may receive a user's card level change input and transmit the received card level change input to the controller 120.

The controller 120 may control an overall operation of the terminal 100.

The communicator 130 may perform communication with the card reader 40 or the server 300. The communicator 130 may receive the card readout information from the card reader 40 and transmit the same the server 300. The communicator 130 may transmit the user's card level change input received by the user interface 110 to the server 300. The communicator 130 may receive a game service providing screen, card level change display information, or the like from the server 300.

The display 140 may display a game service providing screen, a level change target card readout notification, a level change source card readout notification, card level change display information, and the like, which are received from the server 300, on the screen. The display 140 may include at least one of a liquid crystal display (LCD), an organic light emitting display (OLED), an electrophoretic display (EPD), a flexible display, and a three-dimensional (3D) display. Also, there may be two or more displays 140 according to the implementation forms of the terminal 100.

The storage 150 may store the card readout information, the game service providing screen, the level change target card readout notification, the level change source card readout notification, the card level change display information, and the like.

The storage 150 may include at least one type of storage medium among flash memory type, hard disk type, multimedia card micro type, card type memory (e.g., SD or XD memory), RAM, and ROM. Also, the storage 150 may include a virtual space of a cloud environment connected by wired and/or wireless, such as a web storage that performs a storage function on the internet.

According to aspects of the presently disclosed embodiment, in the activation mode of the card 20 in which the card account is generated, the card level change according to the aspects of the presently disclosed embodiment described below may be performed to provide a more secure game service.

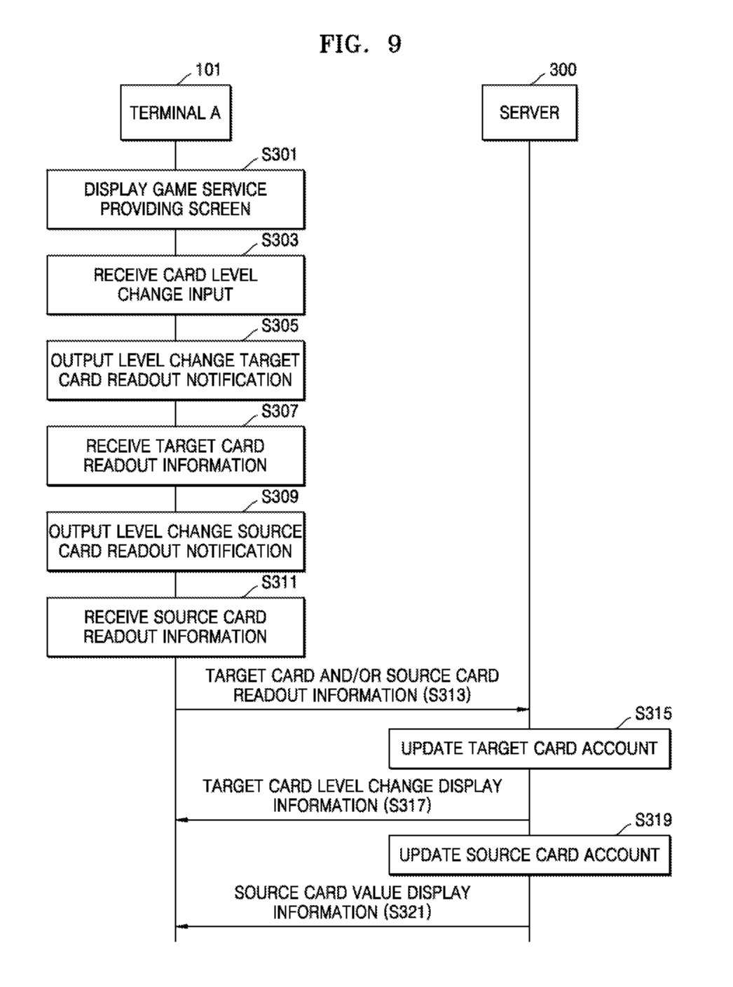

FIG. 9 is a flow diagram schematically illustrating a game service providing method according to an aspect of the presently disclosed embodiment.

Referring to FIG. 9, the terminal 100 may display a game service providing screen (S301). The terminal 100 may display a game service providing screen when receiving a user input for receiving a game service or when detecting an operation of the card reader 40 connected to the terminal 100, but is not limited thereto.

Subsequently, when receiving the card level change input (S303), the terminal 100 may output the level change target card readout notification (S305).

The card level change may include, but is not limited to, changing the card level of the target card by using the source card. The card level change input may be received through the user interface 110 of the terminal 100 or through the card reader 40 connected to the terminal 100, but is not limited thereto. For example, the terminal 100 may receive a card level change input such as a user input for selecting a card level change icon included in the game service providing screen or a user input for selecting a card level change button of the card reader 40 received from the card reader 40.

The terminal 100 may output the level change target card readout notification in response to the card level change input, thereby inducing reception of the target card readout information. For example, the level change target card readout notification may be displayed in the form of a pop-up window on a game service providing screen or in a voice form through a speaker (not illustrated).

When receiving the target card readout information (S307), the terminal 100 may output the level change source card readout notification (S303) and receive the source card readout information (S311). The terminal 100 may output the level change source card readout notification in response to the reception of the target card readout information, thereby inducing reception of the source card readout information. For example, the level change source card readout notification may be displayed in the form of a pop-up window on a game service providing screen or in a voice form through a speaker (not illustrated).

Although not illustrated, according to another aspect of the presently disclosed embodiment, even when the terminal 100 does not output the level change target card readout notification or the level change source card readout notification, when the terminal 100 receives the card readout information through the card reader 40, the terminal 100 may distinguish and recognize whether the received card readout information is the target card readout information or the source card readout information.

Although not illustrated, according to another aspect of the presently disclosed embodiment, even when the terminal 100 does not output the level change target card readout notification or the level change source card readout notification, when the terminal 100 receives a plurality of card readout information at predetermined time intervals, the terminal 100 may recognize the first-received card readout information as the target card readout information and the later-received card readout information as the source card readout information.

The terminal 100 may transmit the target card readout information and/or the source card readout information to the server 300 (S313). The terminal 100 may simultaneously transmit the target card readout information and the source card readout information to the server, may transmit the source card readout information after transmitting the target card readout information, or may transmit the target card readout information after transmitting the source card readout information, but is not limited thereto.

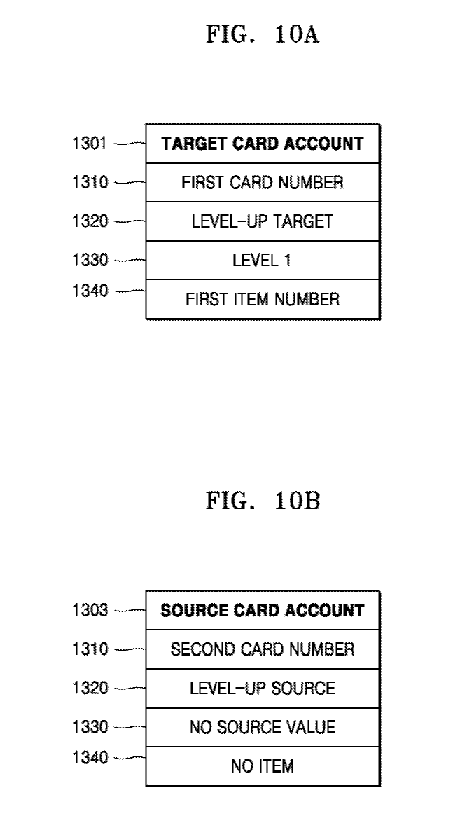

As illustrated in FIG. 10A, the server 300 may update the target card account 1301 based on the target card readout information and the source card readout information received from the terminal 100 (S315).

FIGS. 10A and 10B are diagrams illustrating card accounts updated by a game service providing device according to an aspect of the presently disclosed embodiment.

Referring to FIG. 10A, the server 300 according to an aspect of the presently disclosed embodiment may extract a target card account 1301 in which a first card number is stored in a card identification information field 1310 based on target card readout information, acquire a level 1 change source based on the source card readout information, and store new target card level information indicating the level 1 in a card level information field 1330. That is, the server 300 may apply the level 1 change source acquired from the source card readout information to the default information pre-stored in the card level information field 1330 to generate and store new target card level information indicating the level 1.

Referring again to FIG. 9, when the new target card level information is stored in the card level information field 1330, the server 300 may generate target card level change display information and transmit the same to the terminal 100 (S317).

The target card level change display information may be a screen displaying new level information of the target card or a voice outputting new level information of the target card, but is not limited thereto.

As illustrated in FIG. 10B, the server 300 may update the source card account 1303 based on the source card readout information received from the terminal 100 (S319).

Referring to FIG. 10B, the server 300 according to an aspect of the presently disclosed embodiment may extract a source card account 1303 in which a second card number is stored in the card identification information field 1310 based on the source card readout information, and may acquire a level 1 change source based on the source card readout information. When the result of acquiring the level 1 change source from the second card indicates that no more level change source remains in the second card, the server 300 may store new source card level information indicating that there is no value as a level change source.

Referring again to FIG. 9, for example, when the new source card level information is stored in the card level information field 1330, the server 300 may generate source card level change display information and transmit the same to the terminal 100 (S321).

The source card level change display information may be a screen displaying new level information of the source card or a voice outputting new level information of the source card, but is not limited thereto. The source card may include one level change source, or may include a plurality of level change sources. The source card level information about the source card including one level change source may include information indicating that the card may no longer be utilized as the level change source of the target card. The source card level information about the source card including a plurality of level change sources may include information indicating how many times the card may be utilized as the level change source of the target card in the future.

As described above, according to the aspects of the presently disclosed embodiment, a dummy card that does not include an object usable on an online game may be used to change the card level of a target card, thereby improving the utility of the dummy card and promoting card purchasing.

The game service providing methods according to aspects of the presently disclosed embodiment may be embodied as computer-readable codes on a non-transitory computer-readable recording medium. The computer-readable recording medium may be any recording medium that can store data which is thereafter readable by a computer system. Examples of the computer-readable recording medium include ROM, RAM, CD-ROMs, magnetic tapes, floppy disks, and optical data storage devices. The computer-readable recording medium may also be distributed over network-coupled computer systems so that the computer-readable code is stored and executed by at least one processor in a distributed fashion. Also, functional programs, codes, and code segments for implementing the presently disclosed embodiment maybe easily construed by programmers skilled in the art to which the presently disclosed embodiment pertains.

While the technical spirit of the presently disclosed embodiment has been described with reference to aspects, it will be understood by those of ordinary skill in the art that various modifications and changes can be made thereto without departing from the scope of the presently disclosed embodiment. Therefore, the aspects disclosed in the presently disclosed embodiment are not intended to limit the scope of the presently disclosed embodiment, but are intended to describe the presently disclosed embodiment. The scope of the technical idea of the presently disclosed embodiment is not limited by these aspects. The scope of the protection of the presently disclosed embodiment should be construed by the appended claims. All technical ideas within the scope of equivalents thereof should be construed as falling within the scope of the presently disclosed embodiment.

What is claimed is:

1. A game service providing device for changing a level of a target card by using a source card, the game service providing device comprising:
a communicator configured to receive first payment code readout information comprising source card identification information for identifying the source card, target card readout information of the target card, and source card readout information of the source card;
a database comprising a card identification information field for storing card identification information for identifying a card, a card classification information field for storing card classification information indicating whether a card is a level change target card or a level change source card, a card level information field for storing card level information indicating a current level of a card; and
an account manager configured to generate a source card account corresponding to the source card based on the first payment code readout information, store the source card identification information in a card identification information field of the source card account or store source card classification information indicting that the source card is a level change source card in a card classification information field of the source card account or store first source card level information indicating that the source card has a value as a target card level change source in a card level information field of the source card account, and change the level of each of the target card and the source card based on the target card readout information and the source card readout information.

2. The game service providing device of claim 1, wherein
the communicator receives second payment code readout information comprising target card identification information for identifying the target card, and
the account manager generates a target card account corresponding to the target card based on the second payment code readout information and stores the target card identification information in a card identification information field of the target card account or stores target card classification information indicting that the target card is a level change target card in a card classification information field of the target card account or stores first target card level information in a card level information field of the target card account, wherein the first target card level information is default information.

3. The game service providing device of claim 2, wherein the account manager changes the level of the target card by changing the first target card level information stored in the card level information field of the target card account into second target card level information indicating the level of the target card changed by the source card readout information.

4. The game service providing device of claim 1, wherein the account manager changes the level of the source card by changing the first source card level information stored in the card level information field of the source card account into second source card level information indicating that the source card has no value as the target card level change source by the target card readout information and the source card readout information.

5. The game service providing device of claim 1, wherein
the communicator receives a plurality of source card readout information of each of a plurality of source cards, and the account manager changes the level of the target card based on the target card readout information and the plurality of source card readout information.

6. A game service providing method for changing a level of a target card by using a source card, the game service providing method comprising:
receiving, by a communicator, first payment code readout information comprising source card identification information for identifying the source card;
generating, by an account manager, a source card account corresponding to the source card based on the first payment code readout information;
storing, by the account manager, the source card identification information in a card identification information field of the source card account or storing source card classification information indicting that the source card is a level change source card in a card classification information field of the source card account or storing first source card level information indicating that the source card has a value as a target card level change source in a card level information field of the source card account;
receiving, by the communicator, target card readout information of the target card corresponding to a level change target card readout request;
receiving, by the communicator, source card readout information of the source card corresponding to a level change source card readout request;
changing, by the account manager, the level of each of the target card and the source card based on the target card readout information and the source card readout information; and
generating, by the account manager, target card level change display information in response to a level change of the target card.

7. The game service providing method of claim 6, further comprising:
receiving, by the communicator, second payment code readout information comprising target card identification information for identifying the target card;
generating, by the account manager, a target card account corresponding to the target card based on the second payment code readout information; and
storing, by the account manager, the target card identification information in a card identification information field of the target card account or storing target card classification information indicting that the target card is a level change target card in a card classification information field of the target card account or storing first target card level information in a card level information field of the target card account,
wherein the first target card level information is default information.

8. The game service providing method of claim 7, wherein the changing of the level of the target card comprises changing the first target card level information stored in the card level information field of the target, card account into second target card level information indicating the level of the target card changed by the source card readout information.

9. A computer program stored on a medium to execute the game service providing method of claim 6 by using a computer.
